(19) United States
(12) Patent Application Publication
(10) Pub. No.: US 2007/0050823 A1
(43) Pub. Date: Mar. 1, 2007

(54) Method and apparatus for managing tuners for broadcasting service in home network

(75) Inventors: Kwang-chul Lee, Suwon-si (KR); Ki-seok Chang, Suwon-si (KR); Akhil Chapalamadugu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/509,558

(22) Filed: Aug. 25, 2006

(30) Foreign Application Priority Data
Aug. 25, 2005 (KR) 10-2005-0078391

(51) Int. Cl. H04N 7/18

(52) U.S. Cl. 725/80; 725/74; 725/78

(57) ABSTRACT

A method and apparatus for managing a plurality of tuners for providing a broadcasting service to a plurality of devices in a home network. To provide the broadcast service requested by one of the devices, it is determined whether a tuner to which any broadcast service is pre-assigned can provide the requested broadcast service along with the pre-assigned broadcast service, and the requested broadcast service is additionally assigned to the tuner. If the tuner does not exist, a tuner to which no broadcast service is assigned is detected among from the tuners that can receive a broadcast program corresponding to the requested broadcast service, and the requested broadcast service is assigned to the tuner. Accordingly, in the environment in which various broadcast services are provided to a plurality of devices through a single gateway in a network, the broadcast services can be provided to the devices.

### CROSS-REFERENCE TO RELATED PATENT APPLICATION

This application claims the benefit of Korean Patent Application No. 10-2005-0078391, filed on Aug. 25, 2005, in the Korean Intellectual Property Office, the disclosure of which is incorporated herein in its entirety by reference.

### BACKGROUND OF THE INVENTION

1. Field of the Invention

The present invention relates to a method and apparatus for providing a broadcasting service to devices in a home network, and more particularly, to a method and apparatus for managing tuners for providing a broadcasting service to a plurality of devices in a home network.

2. Description of the Related Art

FIG. 1 illustrates a structure of a conventional digital broadcasting system. Referring to FIG. 1, in the conventional digital broadcasting system, a digital TV (DTV) and a personal video recorder (PVR) are connected to a set top box (STB). The STB receives a digital broadcasting signal transmitted through a satellite, a cable, or a ground wave to record it using the PVR. The DTV is directly connected to the STB and displays a digital broadcasting program received through the satellite, the cable, or the ground wave or displays content stored in the PVR.

FIG. 2 illustrates a structure of a home network including a plurality of devices.

Recently, as communication and broadcasting are becoming merged with electric household appliances at a rapid pace, a service has been introduced in which a broadcasting service is combined with a home network. Internet protocol television (IPTV) is an example of a product for providing the service. Referring to FIG. 2, the home network includes the STB which allows a broadcasting service transmitted from an external broadcasting network to be received through the home network, the DTV which receives the broadcasting service from the home network and displays a broadcast program provided by the broadcasting service, and the PVR which records a broadcasting signal to share the broadcast program through the home network. Devices such as the STB, PVR, and DTV are connected through the IP-based home network to communicate with one another and to share content. The devices can share the broadcasting service using one home gateway. To provide the broadcasting service to the plurality of devices using one home gateway, resource management (i.e., tuner management), which was not a problem when a single user used a conventional DTV system, has to be taken into account. When the plurality of devices share broadcasting services provided via several broadcasting channels using one gateway in the home network, the home gateway requires a plurality of tuners which have to be properly managed to provide the broadcasting service to the devices. However, certified standards for managing the tuners are yet provided.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

Exemplary embodiments of the present invention provide a method and apparatus for managing a plurality of tuners to provide a broadcasting service to a plurality of devices in a home network.

According to an aspect of the present invention, there is provided a method of managing a plurality of tuners to provide a broadcast service at the request of a plurality of devices in a home network, the method comprising detecting a tuner which receives a specific broadcast program to provide a broadcast service requested by one of the devices and selectively assigning the requested broadcast service to one of the tuners according to a result of the detecting.

In addition, it may be determined whether a tuner to which any broadcast service is pre-assigned can provide the requested broadcast service along with the pre-assigned broadcast service, and the requested broadcast service may be additionally assigned to the tuner. If the tuner does not exist, a tuner to which no broadcast service is assigned may be detected among from the tuners that can receive a broadcast program corresponding to the requested broadcast service, and the requested broadcast service may be assigned to the tuner.

According to another aspect of the present invention, there is provided a computer-readable medium having embodied thereon a computer program for executing the method of managing a plurality of tuners to provide a broadcast service to a plurality of devices in a home network.

According to another aspect of the present invention, there is provided an apparatus for managing a plurality of tuners to provide a broadcast service at the request of a plurality of devices in a home network, the apparatus comprising a detect unit detecting a tuner which receives a specific broadcast program to provide a broadcast service requested by one of the devices and an assignment unit assigning the requested broadcast service to the tuner detected by the detect unit.

In addition, the assignment unit may assign the requested broadcast service to one of the tuners that can receive the broadcast program, if the detect unit determines that no broadcast service is assigned to all of the tuners that can receive the broadcast program.

### BRIEF DESCRIPTION OF THE DRAWINGS

The above and other aspects of the present invention will become more apparent by describing in detail exemplary embodiments thereof with reference to the attached drawings in which:

FIG. 1 illustrates a structure of a conventional digital broadcasting system;

FIG. 2 illustrates a structure of a home network including a plurality of devices;

FIG. 3 is a flowchart of a method of managing tuners according to an exemplary embodiment of the present invention;

FIG. 4 illustrates how services interact with one another to perform a method of managing tuners, according to an exemplary embodiment of the present invention;

FIG. 5 illustrates how services interact with one another to perform a method of managing tuner, according to another exemplary embodiment of the present invention;

FIG. 6 illustrates a tuner object according to an exemplary embodiment of the present invention;

FIG. 7 illustrates a recordTask object used in a scheduled recording service (SRS) according to an exemplary embodiment of the present invention;

FIG. 8 illustrates a liveBroadcast object used in a live broadcast service (LBS) according to an exemplary embodiment of the present invention;

FIG. 9 illustrates how services interact with one another when a broadcast service is completed, according to an exemplary embodiment of the present invention; and

FIG. 10 illustrates a structure of an apparatus for managing tuners according to an exemplary embodiment of the present invention.

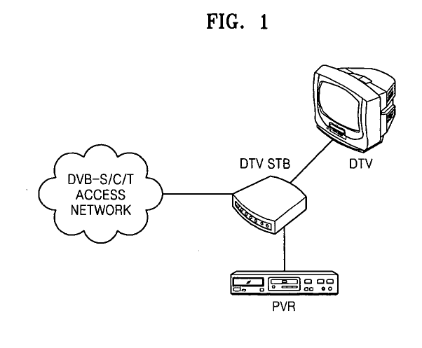

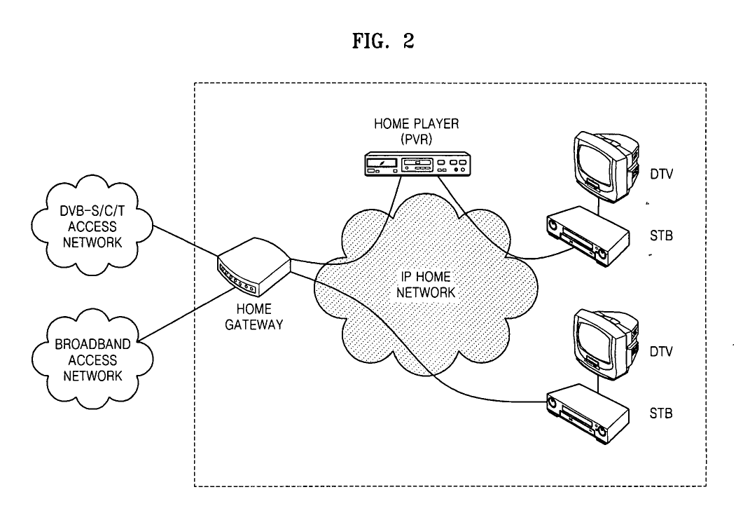

### DESCRIPTION OF THE EXEMPLARY EMBODIMENTS

Hereinafter, the present invention will be described in detail by explaining exemplary embodiments of the invention with reference to the attached drawings.

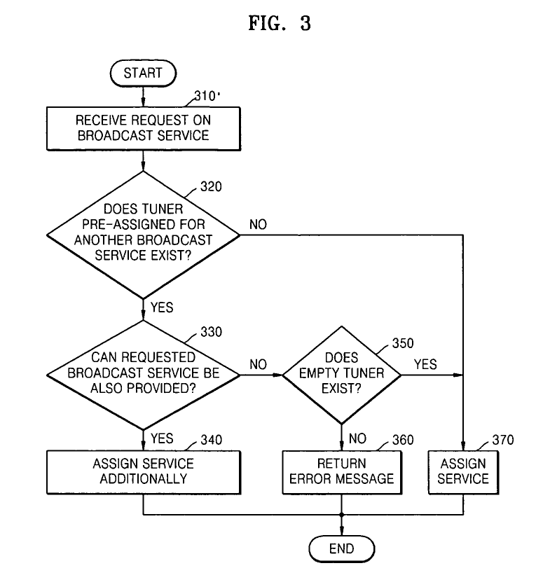

FIG. 3 is a flowchart of a method of managing tuners according to an embodiment of the present invention.

In operation 310, a request to provide a specific broadcasting service is received from any device included in a home network. The broadcasting service may be a live broadcast service or a scheduled recording service. One example of a process of providing the broadcasting service performed by a home gateway is defined in the UPnP AV architecture. Therefore, descriptions thereof will be omitted.

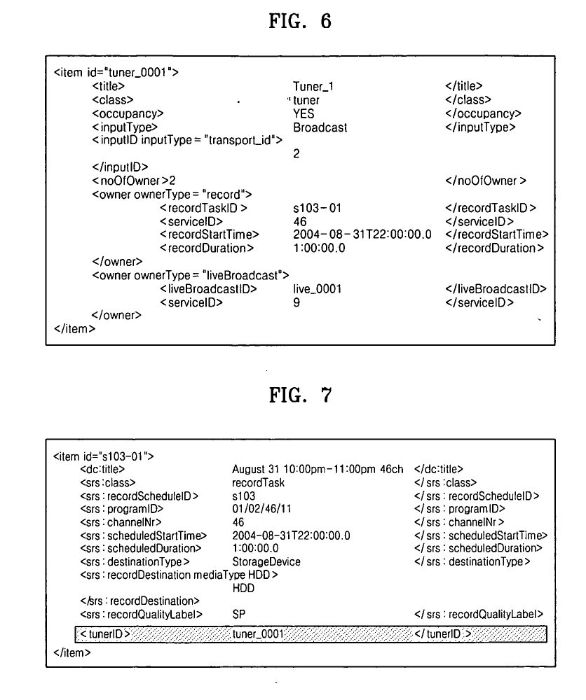

In operation 320, in order to select a tuner to be used for providing a requested broadcasting service, a plurality of tuners are checked to detect a tuner that is pre-assigned for another broadcasting service. If the tuner is detected, then in operation 330 it is determined whether the tuner detected in operation 320 can provide the broadcast service requested in operation 310 along with the broadcast service pre-assigned to the tuner. If it is determined that the tuner exists and can provide the additional broadcast service, then the broadcast service requested in operation 310 is additionally assigned to the tuner. In general, two broadcast services can be provided through a single tuner when the same data is received at the same time. That is, the same broadcast programs are assigned to the single tuner. In this case, regardless of whether the broadcast services are live broadcast services or scheduled recording services, the two broadcast services can be provided through the single tuner. It can be determined whether the same broadcasting services are assigned to the single tuner, according to an input ID of a tuner object which will be described later with respect to FIG. 6. Even when different broadcast programs are assigned to the single tuner, they may be received through the single tuner at the same time according to exemplary embodiments of the invention. In this case, the broadcast programs have the same input IDs.

Although not the same broadcast programs, if broadcast times are different from each other, the two or more broadcast services may be provided through the single tuner.

If it is determined in operation 330 that the tuner does not exist, then in operation 350, another tuner required to provide the requested broadcast service is detected. In other words, when the scheduled recording service is requested for a broadcast program provided through satellite broadcasting, tuners for satellite broadcasting are checked to detect an empty tuner that is not yet assigned for another broadcast service. If the empty tuner does not exist, then in operation 360, an error message is returned to the device that requested the broadcast service in operation 310. If the empty tuner exists, then in operation 370, the requested broadcast service is assigned to the empty tuner.

If it is determined in operation 320 that the tuner pre-assigned for another broadcast service does not exist, then in operation 370, the requested broadcast service is assigned to any empty tuner among tuners that can receive the broadcasting program.

To assign a broadcast service to a tuner, information on a broadcast program is inserted into tuner objects. The number of generated tuner objects equals the number of tuners included in the home gateway. This will be described in detail later.

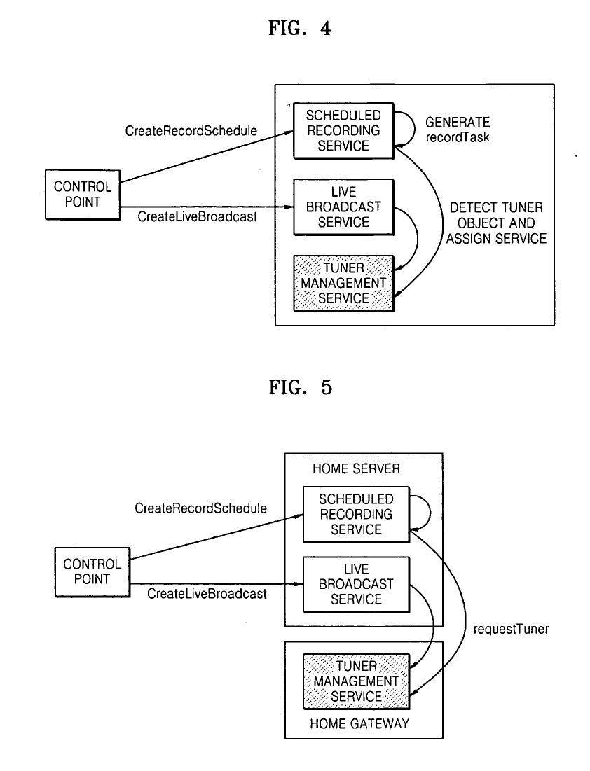

FIG. 4 illustrates how services interact with one another to perform a method of managing tuners, according to an exemplary embodiment of the present invention.

Referring to FIG. 4, a scheduled recording service (SRS), a live broadcast service (LBS), and a tuner management service (TMS) interact with one another in the home gateway. The TMS performs the method of managing tuners. The SRS is currently being standardized by the AV Working Committee of UPnP, and provides a broadcast service by allowing a control point to request scheduled recording of broadcasting data. When any device requests the SRS in the UPnP architecture, as shown in FIG. 4, the control point requests the SRS through CreateRecordSchedule( ) action, and the SRS creates a recordTask object that includes information on the requested scheduled recording task. As described above, in order to assign a tuner required for the requested broadcast service to the recordTask object, the TMS checks tuners that can receive the broadcast service to detect the tuner object to which another broadcast service is pre-assigned by another request. If the tuner object is detected, it is determined whether the requested broadcast service is assigned to the tuner. If it is determined so, the requested broadcast service is additionally assigned to the tuner. If it is determined that the tuner does not exist, the requested broadcast service is assigned to an empty tuner. Also, the same process may be used in the LBS.

FIG. 5 illustrates how services interact with one another to perform a method of managing tuner, according to another exemplary embodiment of the present invention. Referring to FIG. 5, the TMS is separated from the SRS and the LBS. The interaction among services is the same as in FIG. 4. Thus, detailed descriptions thereof will be omitted.

FIG. 6 illustrates a tuner object according to an exemplary embodiment of the present invention.

The number of tuner objects created equals the number of tuners that can be provided by the home gateway. Broadcast programs to be received are respectively assigned to each tuner object.

Referring to FIG. 6, the tuner object has its ID of tuner_{—}001. Further, a scheduled recording service of s103-01 and a live broadcast service of live_{—}001 are currently assigned to the tuner object. When any broadcast service is assigned to the tuner object, an occupancy value becomes YES. The occupancy value of each tuner object is initially set to NO. An input ID identifies broadcast program data received by each tuner object. In this exemplary embodiment of the present invention, the input ID is a transport_id which is used to identify data to be received in the case when broadcasting service data is received through a broadcast access network using for example, but not limited to, a satellite, a cable, or a ground wave. Thus, if two or more broadcast programs have the same Input IDs, the broadcast programs can be received through a single tuner.

FIG. 7 illustrates a recordTask object used in the SRS according to an exemplary embodiment of the present invention.

Referring to FIG. 7, the recordTask object has information on a task for recording a program of a channel 46 into a HDD for 1 hour at 22:00 on Aug. 31, 2004. A tuner ID is a feature of the exemplary embodiments of the present invention, which recognizes a tuner that is assigned for a broadcast service. The assigned tuner in this exemplary embodiment of the present invention is the tuner of which ID is tuner_{—}0001, that is, the tuner indicated by the tuner object of FIG. 6. When the recordTask object is created, each tuner object is checked. If there is a tuner object for which the input ID is the same as that of a broadcast program to be recorded, that is, if there is a tuner that can receive a broadcast program to be recorded in a certain time, then information on a broadcast service corresponding to the tuner object is inserted, and an id value of the tuner object is assigned to a tuner ID value of the recordTask object. If there is no tuner object which has the same input ID with the broadcast program to be recorded, the broadcast service is assigned by selecting a tuner object of which occupancy value is NO. There is no spare tuner to be used if there is no tuner object for which occupancy value is NO. In that case, an error message is returned to the recordTask object. The error message is sent to the device that requested the broadcast service.

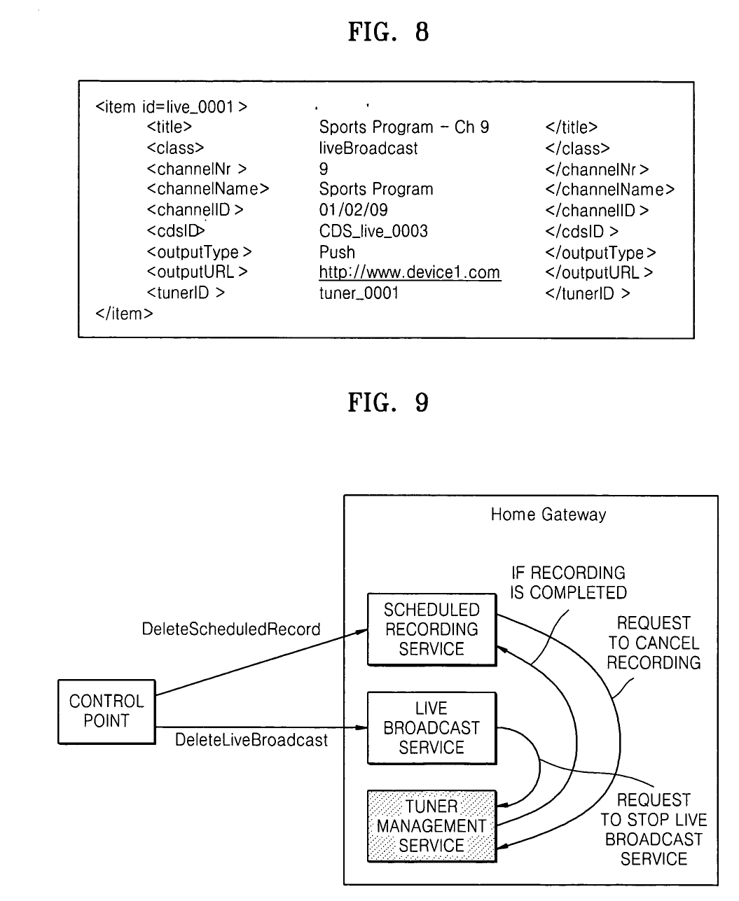

FIG. 8 illustrates a liveBroadcast object used in the LBS according to an exemplary embodiment of the present invention.

As describe in FIG. 4, the control point requests the LBS through a CreateLiveBroadcast action, thereby creating a liveBroadcast object. For example, in this exemplary embodiment of the present invention, a sports program of channel 9 is a broadcast program to be received. As in the case of the SRS, when there is a tuner object for which input ID is the same as that of the broadcast program to be received, information on the broadcast service is assigned to the tuner object, and the ID value of the tuner object is assigned to the tuner ID of the liveBroadcast object. The assigned tuner in this exemplary embodiment of the present invention is the tuner indicated by the tuner object (tuner_{—}001) of FIG. 6. If there is no tuner object for which input ID is the same as that of the broadcast program to be received, information on the broadcast service is assigned by selecting a tuner object for which the occupancy value is NO. There is no spare tuner to be used if there is no tuner object for which occupancy value is NO. In that case, an error message is returned to the liveBroadcast object. The error message is sent to the device that requested the broadcast service.

FIG. 9 illustrates how services interact with one another when a broadcast service is completed, according to an exemplary embodiment of the present invention.

When the SRS is used, in order to cancel the SRS, the control point stops scheduled recording tasks through a DeleteScheduledRecord( ) action, and deletes relevant values of the tuner object. When the SRS is completed, the relevant values of the tuner object are deleted, and this is informed to the recordTask object. In the case of the LBS, when the control point stops the LBS through a DeleteLiveBroadcast( ) action, relevant values of the tuner object are deleted.

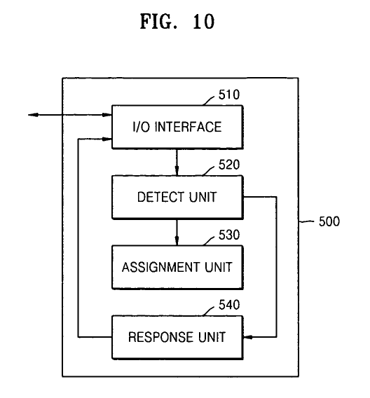

FIG. 10 illustrates a structure of an apparatus for managing tuners according to an exemplary embodiment of the present invention.

Referring to FIG. 10, an apparatus 500 for managing tuners includes an I/O interface 510, a detect unit 520, an assignment unit 530, and a response unit 540.

The I/O interface 510 allows the apparatus 500 for managing tuners to communicate with the control point and devices included in the home network. When a specific broadcast service is requested from any device included in the home network through the I/O interface 510, the detect unit 520 checks the tuners to detect a tuner that is assigned for the requested broadcast service to provide the broadcast service. As described above, it is determined whether there is a tuner to which another broadcast service is pre-assigned by another request. If the tuner exists, it is determined whether there is a tuner for which input ID is the same as that of a broadcast program required to provide the requested broadcast service. If there is no tuner to which the same input ID is assigned, it is checked whether there is an empty tuner that can receive the broadcast program.

The assignment unit 530 receives a check result of the detect unit 520, and assigns the requested broadcast service to the tuner. If there is no tuner to which another broadcast service is pre-assigned by another request, the requested broadcast service is assigned to any empty tuner that can receive the broadcast program. In the case when the tuner exists to which the broadcast service is pre-assigned by another request, and there is no tuner for which input ID is the same as that of the requested broadcast service, but an empty tuner that can receive the broadcast service exists, the requested broadcast service is assigned to the empty tuner.

If other broadcast services are pre-assigned to all tuners, and if there is no tuner for which input ID is the same as that of the broadcast program required to provide the requested broadcast services, the response unit 540 generates an error message and sends the error message to the control point or the device that requested the broadcast service.

Accordingly, the exemplary embodiments of the present invention provide a method of managing a plurality of tuners when a plurality of devices separately request various broadcast services in the environment in which the broadcast services are provided to the devices through a single home gateway in a home network, so that the broadcast services can be effectively provided to the devices.

The exemplary embodiments of the present invention can be written as computer programs stored on computer readable recording media and can be implemented in general-use digital computers that execute the programs using a computer readable recording medium. Examples of the computer readable recording medium include, but are not limited to, magnetic storage media (e.g., ROM, floppy disks, hard disks, etc.), optical recording media (e.g., CD-ROMs, or DVDs), and storage media such as carrier waves (e.g., transmission through the Internet).

Although the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of managing a plurality of tuners in a network, the method comprising:
detecting a tuner which receives a specific broadcast program to provide a broadcast service requested by one of a plurality of devices in the network; and
selectively assigning the requested broadcast service to one of the tuners according to a result of the detecting.

2. The method of claim 1, wherein the detecting a tuner which receives a specific broadcast program operation comprises:
detecting a tuner to which any broadcast service is pre-assigned among from the tuners; and
determining whether the tuner detected in the detecting a tuner to which any broadcast service is pre-assigned operation provides the requested broadcast service along with the pre-assigned broadcast service.

3. The method of claim 2, wherein the detecting a tuner which receives a specific broadcast program operation further comprises detecting a tuner to which no broadcast service is assigned among tuners that can receive the broadcast program, if the determining whether the tuner detected operation determines that the tuner does not exist.

4. The method of claim 2, wherein, in the detecting a tuner which receives a specific broadcast program operation, the requested broadcast service is assigned to a tuner to which no broadcast service is assigned among tuners that can receive the broadcast program, if there is no tuner detected in the detecting a tuner to which any broadcast service is pre-assigned operation.

5. The method of claim 2, wherein, in the detecting a tuner which receives a specific broadcast program operation, the requested broadcast service is additionally assigned to the tuner determined in the determining whether the tuner detected operation.

6. The method of claim 3, wherein, in the detecting a tuner which receives a specific broadcast program operation, an error message is returned to the device, if there is no tuner detected in the detecting a tuner to which no broadcast service is assigned operation.

7. The method of claim 1, wherein the requested broadcast service is a live broadcast service or a scheduled recording service for the broadcast program.

8. The method of claim 1 wherein the network is a home network.

9. An apparatus for managing a plurality of tuners in a network, the apparatus comprising:
a detect unit detecting a tuner which receives a specific broadcast program to provide a broadcast service requested by one of a plurality of devices in the network; and
an assignment unit assigning the requested broadcast service to the tuner detected by the detect unit.

10. The apparatus of claim 9, wherein the detect unit determines if a tuner to which a broadcast service is pre-assigned can provide the requested broadcast service in addition to the pre-assigned broadcast service.

11. The apparatus of claim 10, wherein the detect unit detects a tuner to which no broadcast service is assigned among tuners that can receive the broadcast program, if the tuner to which the broadcast service is pre-assigned cannot provide the requested broadcast service in addition to the pre-assigned broadcast service.

12. The apparatus of claim 9, wherein the assignment unit assigns the requested broadcast service to a tuner that can receive the broadcast program, if the detect unit determines that no broadcast service is assigned to the tuners that can receive the broadcast program.

13. The apparatus of claim 9, wherein the assignment unit assigns the requested broadcast service to the tuner to which a broadcast service is pre-assigned that can provide the requested broadcast service along with the pre-assigned broadcast service, according to a determination result of the detect unit.

14. The apparatus of claim 9, further comprising a response unit returning an error message to the one of a plurality of devices, if no tuner is detected by the detect unit.

15. The apparatus of claim 9, wherein the requested broadcast service is a live broadcast service or a scheduled recording service.

16. The apparatus of claim 9 wherein the network is a home network.

17. The apparatus of claim 16 wherein the home network further comprises a gateway.

18. The apparatus of claim 17 wherein the gateway further comprises:
a scheduled recording service;
a live broadcast service; and
a tuner management service.

19. The apparatus of claim 9 further comprising an input-output interface communicating with a control point.

20. A computer-readable medium having embodied thereon a computer program for executing the method of claim 1.

21. A computer-readable medium having embodied thereon a computer program for executing the method of claim 2.

22. A computer-readable medium having embodied thereon a computer program for executing the method of claim 3.

23. A computer-readable medium having embodied thereon a computer program for executing the method of claim 4.

24. A computer-readable medium having embodied thereon a computer program for executing the method of claim 5.

25. A computer-readable medium having embodied thereon a computer program for executing the method of claim 6.

26. A computer-readable medium having embodied thereon a computer program for executing the method of claim 7.
